(19) United States
(12) Patent Application Publication
(10) Pub. No.: US 2008/0142364 A1
(43) Pub. Date: Jun. 19, 2008

(54) Gas sensor element designed to minimize direct exposure to water

(75) Inventor: Susumu Naito, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/000,306

(22) Filed: Dec. 11, 2007

(30) Foreign Application Priority Data
Dec. 15, 2006 (JP) 2006-337912

(51) Int. Cl. G01N 27/26

(52) U.S. Cl. 204/427

(57) ABSTRACT

A gas sensor element is equipped with a hollow body which is closed at one of opposed ends and has a gas inlet formed in the other end through which gas to be measured enters. The hollow body includes an oxygen ion-conductive solid electrolyte member, a gas-exposed electrode which is affixed to a first area of an inner surface of the solid electrolyte member, and a reference gas-exposed electrode which is affixed to a second area of an outer surface of the solid electrolyte member. The second area is aligned with the first area in a direction perpendicular to a flow of the gas. A heater is disposed on an area of the hollow body which faces the electrodes. This structure servers to minimize direct exposure of water carried by the flow of the gas to a heated area of the hollow body, thereby avoiding cracks in the hollow body.

### CROSS REFERENCE TO RELATED DOCUMENT

The present application claims the benefit of Japanese Patent Application No. 2006-337912 filed on Dec. 15, 2006, disclosure of which is incorporated herein by reference.

### BACKGROUND OF THE INVENTION

1. Technical Field of the Invention

The present invention relates generally to a gas sensor element to be built in a gas sensor which may be installed in an exhaust system of an internal combustion engine to determine the concentration of a gas component contained in exhaust emissions, and more particularly to an improved structure of such a type of gas sensor element designed to minimize direct exposure to water without sacrificing the performance thereof.

2. Background Art

There are known gas sensors designed to produce an output as a function of the concentration of oxygen for use in measuring the concentration of NOx, HC, or CO or controlling an air-fuel ratio of a fuel mixture to be charged into an internal combustion engine.

For instance, the above type of gas sensors may be installed in an exhaust system of automotive internal combustion engines to sample the concentration of oxygen contained in exhaust emissions to determine the air-fuel ratio of a fuel mixture for use in controlling the burning of the fuel mixture in the engine. This is generally called an exhaust gas feedback control system. Particularly, it is essential for enhancing the efficiency in converting harmful emissions into less harmful substances through a three-way catalyst to bring the air-fuel ratio in the combustion chamber of the engine into agreement with a target value.

Japanese Patent First Publication No. 2000-65782 discloses a gas sensor having installed therein a sensor element working to measure the concentration of oxygen contained in exhaust emissions of automotive internal combustion engines. The sensor element is made up of an oxygen ion-conductive solid electrolyte body, a gas electrode which is affixed to one of opposed surfaces of the solid electrolyte body and exposed to gas to be measured, and a reference gas electrode which is affixed to the other surface of the solid electrolyte body and exposed to a reference gas. The sensor element works to produce an output as a function of a difference in concentration of oxygen between the gas to be measured and the reference gas for use in determining the concentration of a given component of the gas or the air-fuel ratio of a fuel mixture charged into the engine.

In recent years, the above type of gas sensors have been required to have an improved ability to be activated quickly. This is achieved, for example, by installing a high-powered heater in the gas sensor to heat the sensor element quickly upon start-up of the engine. Usually, dew drops of water, as condensed within an exhaust pipe extending from the engine upon start-up of the engine, are blown away by a flow of exhaust gas and hit the sensor element being heated, which may result in cracks in the sensor element.

In order to alleviate the above problem, the gas sensor is installed deep in the exhaust pipe to enhance the accuracy in sensing the exhaust gas and equipped with a protective cover assembly to shield the sensor element from the flow of exhaust gas. Specifically, the protective cover assembly is used to limit the amount of exhaust gas flowing into the gas sensor greatly to avoid the exposure of the sensor element to the drops of water.

It is, however, difficult for such a gas sensor to minimize the exposure of the sensor element to the drops of water without sacrificing the performance of the sensor element itself only using the protective cover assembly.

### SUMMARY OF THE INVENTION

It is therefore an object of the invention to provide an improved structure of a gas sensor element to be built in a gas sensor which is designed to minimize direct exposure to water without sacrificing the performance thereof.

According to one aspect of the invention, there is provided a gas sensor element to be built in a gas sensor which may be employed in measuring the concentration of a gas component contained in exhaust emissions of an internal combustion engine of an automotive vehicle. The gas sensor element comprises: (a) a hollow body with a length which is closed at one of opposed ends and has a gas inlet formed in the other of the opposed ends through which gas to be measured enters a gas chamber defined inside the hollow body; (b) an oxygen ion-conductive solid electrolyte member which forms a portion of the hollow body; (c) a gas-exposed electrode which is affixed to a first area of an inner surface of the solid electrolyte member and to be exposed to the gas to be measured; and (d) a reference gas-exposed electrode which is affixed to a second area of an outer surface of the solid electrolyte member and to be exposed to a reference gas. The second area is aligned with the first area in a thickness-wise direction of the solid electrolyte member.

The gas enters the hollow body and reaches the gas-exposed electrode disposed on the inner surface of the hollow body. The gas-exposed electrode is, as described above, attached to the inner surface of the solid electrolyte member and located deep inside the hollow body. This minimizes the amount of water entering deep inside a gas chamber defined within the hollow body, thereby avoiding cracks in the hollow body.

In the preferred mode of the invention, the portion of the hollow body, as formed by the solid electrolyte, is a portion of a transverse section area of the hollow body. The gas sensor element may also include an electric insulating heater holder which has a heater retained therein and forms another portion of the transverse sectional area of the hollow body. The heater works to bring the gas sensor element to an activated state quickly and is aligned with the gas-exposed electrode and the reference gas-exposed electrode in a direction transverse to a lengthwise direction of the hollow body.

A minimum distance between the gas inlet and the heater is selected to be greater than a maximum distance between portions of an inner wall of the gas inlet. This minimizes the reach of the water to an area of the hollow body, as heated by the heater, thus decreasing cracks in the hollow body.

The heater may be located 10 mm or more away from the gas inlet.

The gas sensor element may also include porous members which cover the gas-exposed electrode and an inner area of the hollow body which is exposed to the gas chamber and to be heated by the heater.

According to the second aspect of the invention, there is provided a gas sensor which comprises: a gas sensor element and a housing. The gas sensor element includes (a) a hollow body with a length which is closed at one of opposed ends and has a gas inlet formed in the other of the opposed ends through which gas to be measured enters a gas chamber defined inside the hollow body, (b) an oxygen ion-conductive solid electrolyte member which forms a portion of the hollow body, (c) a gas-exposed electrode which is affixed to a first area of an inner surface of the solid electrolyte member and to be exposed to the gas to be measured, and (d) a reference gas-exposed electrode which is affixed to a second area of an outer surface of the solid electrolyte member and to be exposed to a reference gas. The second area is aligned with the first area in a thickness-wise direction of the solid electrolyte member. The housing defines a reference gas chamber which is to be filled with the reference gas. The housing retains the gas sensor element to be exposed to the reference gas chamber and has the gas inlet opening outside the housing so that the gas to be measured flows into the gas chamber of the hollow body from a pipe extending outside the housing.

In the preferred mode of the invention, the housing is so designed as to have the gas inlet of the hollow body located inside the pipe and the gas-exposed electrode and the reference gas-exposed electrode disposed outside the pipe.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a gas sensor element according to the first embodiment of the invention;

FIG. 2 is a transverse sectional view of FIG. 1;

FIG. 3 is a longitudinal sectional view which shows a gas sensor in which the gas sensor element of FIG. 1 is installed; and

FIG. 4 is a longitudinal sectional view which shows a gas sensor element according to the second embodiment of the invention.

### DESCRIPTION OF THE PREFERRED EMBODIMENTS

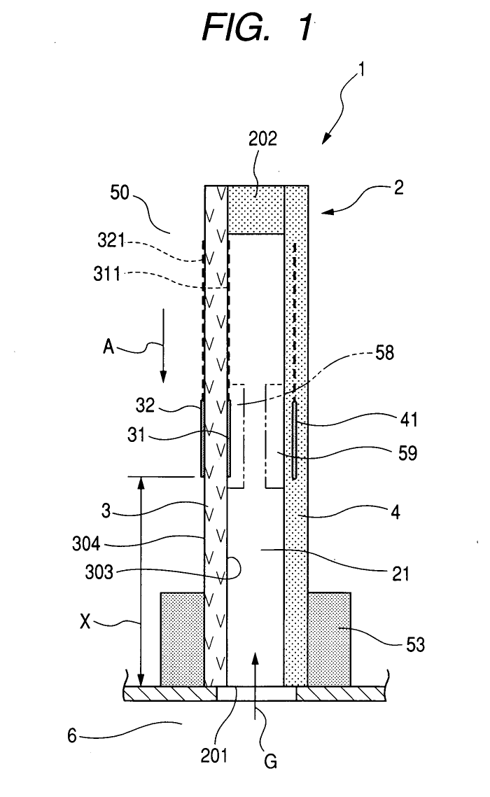

Referring to the drawings, wherein like reference numbers refer to like parts in several views, particularly to FIGS. 1 to 3, there is shown a gas sensor 10 according to the invention which may be engineered as an A/F sensor for use in an automotive exhaust gas feedback system, an oxygen (O₂) sensor to measure the concentration of oxygen (O₂) contained in exhaust gas emitted from an internal combustion engine, or a NOx sensor for use in monitoring the deterioration of a three-way catalyst installed in an exhaust pipe of the engine.

The gas sensor 10 is equipped with a sensor element 1. The sensor element 1 includes an oxygen ion-conductive solid electrolyte plate 3, a gas-exposed electrode 31 which is affixed to the solid electrolyte plate 3 and to be exposed to gas G to be measured (which will also be called a measurement gas below), and a reference gas-exposed electrode 32 which is affixed to the solid electrolyte plate 3 and to be exposed to a reference gas A (e.g., air).

The sensor element 1 also includes an electrical insulating heater holder plate 4 in which a heater 41 is embedded. The heater holder plate 4 and the solid electrolyte plate 3 define opposed side walls of a rectangular parallelepiped body 2. The rectangular parallelepiped body 2 has a bottom 202 and an opening formed as a gas inlet 201. The gas inlet 201 is opposed to the bottom 202 in a lengthwise direction of the rectangular parallelepiped body 2.

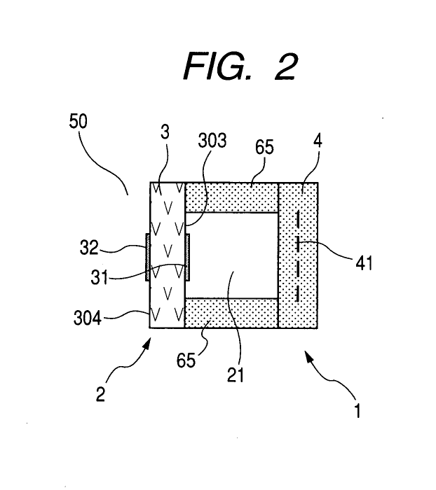

The gas-exposed electrode 31 is affixed to an inner surface 303 of the solid electrolyte plate 3. The reference gas-exposed electrode 32 is affixed to an outer surface 304 of the solid electrolyte plate 3. The gas-exposed electrode 31 is, as clearly illustrated in FIGS. 1 and 2, opposed to the reference gas-exposed electrode 32 in a thickness-wise direction of the solid electrolyte plate 31.

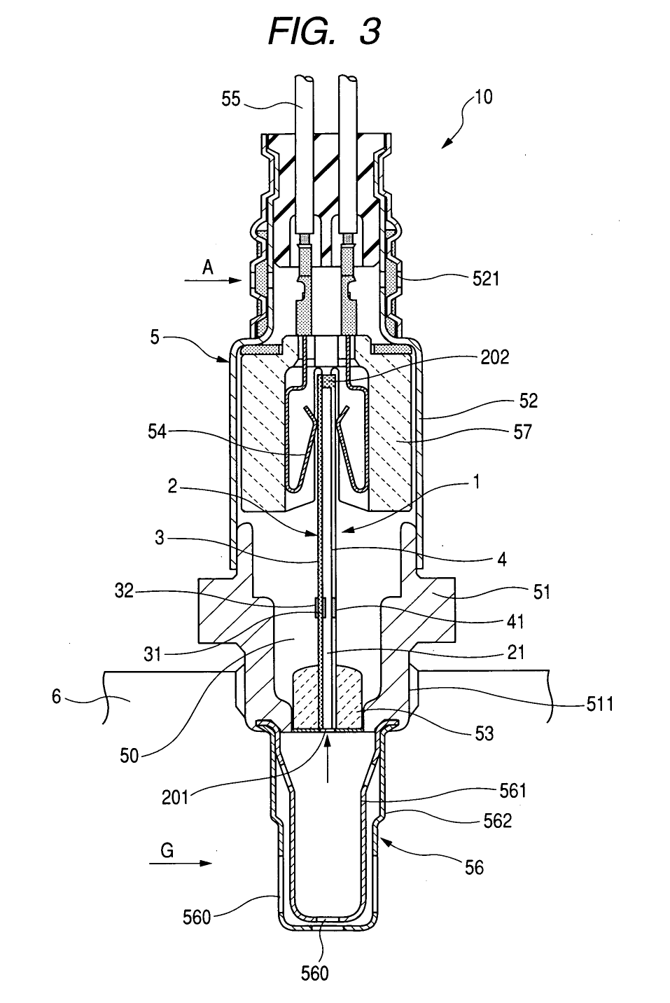

In use, the gas sensor 10 is, as illustrated in FIG. 3, installed in an exhaust pipe 6 extending from an internal combustion engine to measure the concentration of oxygen contained in exhaust gas (i.e., the measurement gas G) flowing through the exhaust pipe 6 and works as an A/F sensor designed to produce a limiting current as representing an air-fuel ratio of a fuel mixture charged into the engine for use in air-fuel ratio control for the engine.

The solid electrolyte plate 3 is made of a ceramic material such as zirconia. The heater holder plate 4 is made of a ceramic material such as alumina.

The rectangular parallelepiped body 2, as described above, includes the solid electrolyte plate 3 and the heater holder plate 4 which are joined to each other through rectangular spacers 65. The spacers 65 have a given thickness and define opposed side walls of the rectangular parallelepiped body 2. The solid electrolyte plate 3, the heater holder plate 4, and the spacers 65 may alternatively be shaped to form a hollow body such as a hollow cylinder instead of the rectangular parallelepiped body 2. The heater holder plate 4 may be made of two insulating layers between which the heater 41 is nipped.

The heater 41 embedded in the heater holder plate 4 is, as can be seen from FIG. 1, located to face the gas-exposed electrode 31 and the reference gas-exposed electrode 32 in a direction traversing the length of the rectangular parallelepiped body 2 (i.e., the longitudinal direction of the gas sensor 10). The heater holder plate 4 extends substantially parallel to the solid electrolyte plate 3 so as to face it through a gas chamber 21 filled with the measurement gas G.

A minimum distance X, as indicated in FIG. 1, between the gas inlet 201 and the heater 41 is selected to be greater than a minimum distance between portions of an inner wall of the gas inlet 201. For instance, the heater 41 is located 10 mm or more (e.g., 15 mm) away from the gas inlet 201 of the rectangular parallelepiped body 2. In other words, the minimum distance X between the gas inlet 201 and the heater 41 is 10 mm or more.

The gas sensor 10 includes, as shown in FIG. 3, a hollow housing assembly 5 which defines therein a reference gas chamber 50 filled with the reference gas A (i.e., the air). The sensor element 1 is retained in the reference gas chamber 50. The housing assembly 5 is made up of a front housing 51 and a rear housing 52. The front housing 51 has formed on a circumferential wall thereof an external thread 511 which engages an internal thread formed in the exhaust pipe 6 to secure the gas sensor 10 to the exhaust pipe 6. The rear housing 52 is joined or welded to the front housing 51. The sensor element 1 is retained at one of ends thereof by the front housing 51 through a mount block 53 ant at the other end by the rear housing 52 through a hollow cylindrical insulator 57.

The rear housing 52 has formed therein reference gas inlets 521 through which the reference gas A flows inside the housing assembly 5. The gas inlet 201 of the rectangular parallelepiped body 2 opens outside the front housing 51.

The gas sensor 10 is, as clearly illustrated in FIG. 3, attached to the exhaust pipe 6 with a top portion of the front housing 51 disposed inside the exhaust pipe 6 to have the gas inlet 201 of the rectangular parallelepiped body 2 exposed to the exhaust gas G within the exhaust pipe 6. the gas-exposed electrode 31, the reference gas-exposed electrode 32, and the heater 41 are located outside the exhaust pipe 6.

The gas-exposed electrode 31 and the reference gas-exposed electrode 32 are electrically connected to leads 55 through conductors 311 and 321 and conductive springs 54. The conductors 311 and 321 are formed on the inner and outer surfaces 304 and 303 of the solid electrolyte plate 3. The conductive springs 52 are retained within the insulator 57 to make electrical connections between the conductors 311 and 321 and the leads 55. The leads 55 extend outside the gas sensor 10 and connect with an external controller (not shown).

The gas sensor 10 also includes a double-walled protective cover assembly 56 joined to a top end of the front housing 51 to define a gas chamber filled with the measurement gas G. The protective cover assembly 56 is made up of an inner cover 561 and an outer cover 562 disposed outside the inner cover 561. The inner and outer covers 561 and 562 have formed therein gas holes 560 through which the measurement gas G pass. The gas inlet 201 of the rectangular parallelepiped body 2 is exposed to the gas chamber within the protective cover assembly 56.

The reference gas-exposed electrode 31 is, as illustrated in FIG. 1, covered with a porous layer 58. Similarly, an area of the inner surface of the heater holder plate 4 aligned with the heater 41 in the thickness-wise direction of the heater holder plate 4 is covered with a porous layer 59. This avoids direct exposure of the gas-exposed electrode 31 to drops of water and harmful or poisonous substances contained in the measurement gas G.

The operation of the gas sensor 10 will be described below.

The measurement gas (i.e., the exhaust gas) G flowing through the exhaust pipe 6 enters the gas chamber 21 of the rectangular parallelepiped body 2 at the gas inlet 201. The measurement gas G then reaches the gas-exposed electrode 31 affixed to the inner surface 303 of the solid electrolyte plate 3. An electrical current is developed between the gas-exposed electrode 31 and the reference gas-exposed electrode 32 as a function of the concentration of oxygen (O₂). The gas sensor 10 outputs the electrical current as representing the air-fuel ratio of a fuel mixture charged into the engine. This operation of the sensor element 10 is typical and known in the art, and explanation thereof in detail will be omitted here.

Upon start-up of the engine, the external controller (not shown) energizes the heater 41 to heat around the reference gas-exposed electrode 31 and the reference gas-exposed electrode 32 to bring the sensor element 1 to an activated state quickly.

The gas-exposed electrode 31 is, as described above, attached to the inner surface 303 of the solid electrolyte plate 3 and located deep inside the rectangular parallelepiped body 2. The heater 41 is disposed to face the gas-exposed electrode 31 in a direction transverse to the flow of the measurement gas G. This causes the drops of water having entered at the gas inlet 201 together with the measurement gas G to be adhered an area of the inner wall of the rectangular parallelepiped body 2 located upstream of the heater 41 so that they are evaporated on a side upstream of the heater 41, thereby minimizing the adhesion of the drops of water to an area of the inner wall of the rectangular parallelepiped body 2 which is heated by the heater 41 to avoid cracks in such an area.

The rectangular parallelepiped body 2 is retained inside the housing assembly 5 so that the area thereof to be exposed to the heat, as produced by the heater 41, is located outside the exhaust pipe 6 when the gas sensor 10 is installed in the exhaust pipe 6, thereby further minimizing the adhesion of the drops of water contained in the measurement gas G to the heated area.

The reference gas-exposed electrode 32 is disposed on the outer surface 304 of the solid electrolyte plate 3, thus minimizing the gas diffusion resistance of the periphery of the reference gas-exposed electrode 32. Particularly, when the measurement gas G (i.e., the exhaust gas) is in a fuel rich state (i.e., very low in oxygen content), the ease with which oxygen ions travel from the reference gas-exposed electrode 32 to the gas-exposed electrode 31 is enhanced, thereby resulting in improved characteristics of the sensor element 1, that is, an increased range in which it is possible to measure the air-fuel ratio of a fuel mixture charged into the engine.

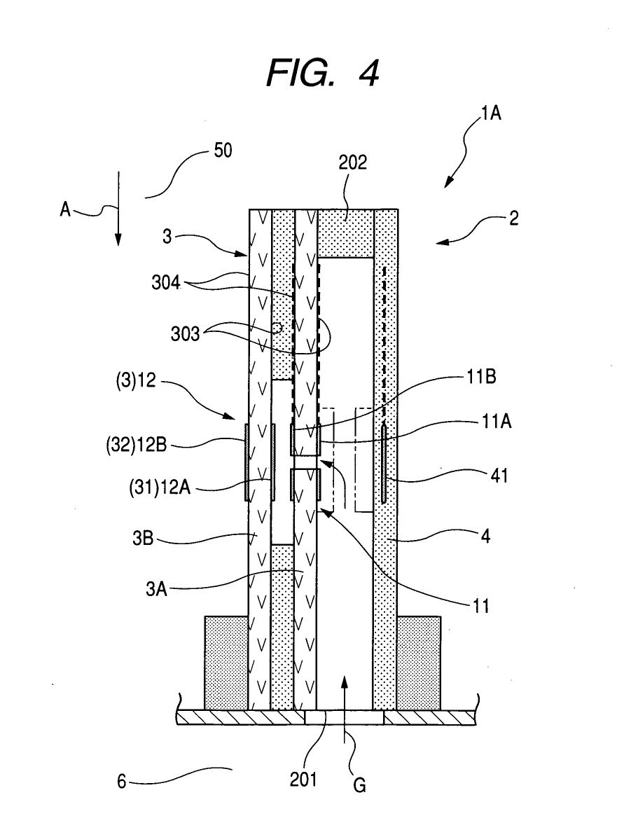

FIG. 4 illustrates a sensor element 1A according to the second embodiment of the invention which may be employed in the gas sensor 10 of FIG. 3.

The sensor element 1A is of a two-cell type which includes a pump cell 11 and a sensor cell 12. Specifically, the solid electrolyte plate 3 is made up of an inner solid electrolyte layer 3A and an outer solid electrolyte layer 3B which are joined together through a spacer. The inner solid electrolyte layer 3A has a pump cell electrode 11A affixed to the inner surface 303 thereof and a pump cell electrode 11B affixed to the outer surface 304 thereof. The outer solid electrolyte layer 3B has a sensor cell electrode 12A affixed to the inner surface 303 thereof as the gas-exposed electrode 31 and a sensor cell electrode 12B affixed to the outer surface 304 thereof as the reference gas-exposed electrode 32.

The sensor element 1 may alternatively be designed to measure the concentration of NOx, HC, or CO and also designed as a complex sensor element to measure a given gas component and an air-fuel ratio of exhaust gasses simultaneously.

A trap layer having a low diffusion resistance may be formed around the gas inlet 210 of the rectangular parallelepiped body 2 in order to avoid the entrance of the drops water into the sensor element 1.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas sensor element comprising:
a hollow body with a length which is closed at one of opposed ends and has a gas inlet formed in the other of the opposed ends through which gas to be measured enters a gas chamber defined inside said hollow body;
an oxygen ion-conductive solid electrolyte member which forms a portion of said hollow body;
a gas-exposed electrode which is affixed to a first area of an inner surface of said solid electrolyte member and to be exposed to the gas to be measured; and
a reference gas-exposed electrode which is affixed to a second area of an outer surface of said solid electrolyte member and to be exposed to a reference gas, the second area being aligned with the first area in a thickness-wise direction of said solid electrolyte member.

2. A gas sensor element as set forth in claim 1, wherein the portion of said hollow body, as formed by said solid electrolyte, is a portion of a transverse section area of said hollow body, and further comprising an electric insulating heater holder which has a heater retained therein and forms another portion of the transverse sectional area of said hollow body, the heater being aligned with said gas-exposed electrode and said reference gas-exposed electrode in a direction transverse to a lengthwise direction of said hollow body.

3. A gas sensor element as set forth in claim 2, wherein a minimum distance between the gas inlet and the heater is greater than a maximum distance between portions of an inner wall of the gas inlet.

4. A gas sensor element as set forth in claim 3, wherein the heater is located 10 mm or more away from the gas inlet.

5. A gas sensor element as set forth in claim 1, further comprising a porous member which covers said gas-exposed electrode.

6. A gas sensor element as set forth in claim 1, further comprising a porous member which covers an inner area of said hollow body which is exposed to the gas chamber and to be heated by the heater.

7. A gas sensor comprising:
a gas sensor element including (a) a hollow body with a length which is closed at one of opposed ends and has a gas inlet formed in the other of the opposed ends through which gas to be measured enters a gas chamber defined inside said hollow body, (b) an oxygen ion-conductive solid electrolyte member which forms a portion of said hollow body, (c) a gas-exposed electrode which is affixed to a first area of an inner surface of said solid electrolyte member and to be exposed to the gas to be measured, and (d) a reference gas-exposed electrode which is affixed to a second area of an outer surface of said solid electrolyte member and to be exposed to a reference gas, the second area being aligned with the first area in a thickness-wise direction of said solid electrolyte member; and
a housing defining a reference gas chamber which is to be filled with the reference gas, said housing retaining said gas sensor element to be exposed to the reference gas chamber and having the gas inlet opening outside said housing so that the gas to be measured flows into the gas chamber of the hollow body from a pipe extending outside said housing.

8. A gas sensor as set forth in claim 7, wherein said housing is so designed as to have the gas inlet of said hollow body located inside the pipe and the gas-exposed electrode and the reference gas-exposed electrode disposed outside the pipe.
